(19) United States
(12) Patent Application Publication
(10) Pub. No.: US 2012/0302275 A1
(43) Pub. Date: Nov. 29, 2012

(54) COGNITIVE CONTROL NETWORK SELECTION

(75) Inventors: Jari Junell, Espoo (FI); Juha Salokannel, Tampere (FI); Paivi Ruuska, Tampere (FI)

(73) Assignee: Nokia Corporation, Espoo (FI)

(21) Appl. No.: 13/521,269

(22) PCT Filed: Feb. 17, 2010
(86) PCT No.: PCT/FI10/50102

§ 371 Date: Jul. 10, 2012

(51) Int. Cl. H04W 72/08; H04W 48/18

(52) U.S. Cl. 455/514; 455/515

(57) ABSTRACT

In accordance with an example embodiment of the present invention, an apparatus (by example a node with a cognitive control radio CCR) receives first and second messages indicating at least one of a number of nodes per cognitive radio network and amount of traffic per cognitive radio network participating to a respective first and second cognitive control network CCN. The node selects one of the first and second cognitive control network based at least partly on at least one of the number of participating nodes and the amount of traffic per similar cognitive radio network for which the apparatus is capable of accessing. In a specific embodiment, the selection is according to a predefined set of rules, such as select only a channel that appears to be free of primary users; scan a predefmed set of frequency channels in a predefined order; and others. If there are no suitable pre-existing cognitive control networks CCNs available, there are also rules for establishing a new CCN. Described are apparatus, method, and a memory storing a computer program for the various embodiments.

### TECHNICAL FIELD

The teachings herein relate generally to wireless networks and devices operating among such networks, and are particularly related to cognitive radios that operate opportunistically using portions of radio spectrum not currently in use by networks that have designated radio resources.

### BACKGROUND

The following abbreviations are used within the description below:

AP access point

CCC cognitive control channel

CCN cognitive control network (for control signaling)

CCR cognitive control radio

CRN cognitive radio network (for user data)

CSMA-CA carrier sensing multiple access-channel assessment

DB database

E-UTRAN evolved UTRAN

FCC federal communications commission (US)

GERAN GSM/EDGE radio access network

GSM global system for mobile telecommunications

ISM industrial, scientific and medical (originally reserved for these uses)

UTRAN universal terrestrial radio access network

TDD time division duplex

WS white space

Cognitive radios find empty time-frequency slots in the radio spectrum which they use in an opportunistic manner so as to put these wasted radio resources to use. For example, in the United States the FCC has opened the former television bands, named White Spaces, for unlicensed devices which can use that spectrum without interfering with licensed users. These unlicensed secondary users need to avoid interfering with the primary (licensed) users, when and where such primary users are active. Cognitive radios use spectrum sensing to dynamically find these opportunistic holes and communicate user data with one another within a CRN using those holes.

Primary users are those to whom the specific frequency band is licensed (for example, those to whom are allocated slots) such as those operating in hierarchical or other such formal networks (for example, cellular such as GSM, GERAN, UTRAN, E-UTRAN, broadcast systems such as television systems, and also satellite systems such as GPS, IRIDIUM). There are other networks such as WLAN, Bluetooth, ANT and Zigbee for example which operate in the ISM band, but since ISM is not licensed users in the ISM band are not considered to be primary users.

Co-owned U.S. Provisional Patent Application No. 61/244,692 entitled “Cognitive Control Radio Access Information Via Database or Cognitive Pilot Channel”, filed Sep. 22, 2009 describe that secondary users might share spectrum sensing results and obtain the frequencies needed to avoid interfering with primary users via a database or a pilot channel. The FCC also has a whitespace database of TV signals and locations. A cognitive pilot channel (CPC) has also been introduced in a European Union's 6th Framework program project End-to-End Reconfigurability (E²R). But it may arise that at least some nodes do not have access to such a database or cognitive pilot channel.

IEEE 802.19 is starting coexistence solution definitions for TV white space secondary users. A CCN is a potential solution for coexistence in TV White Spaces, and also for other bands being opened for secondary users. In practice there may be two or more CCNs already in operation in a given area, in which case a joining cognitive node might need to choose which of those CCNs to join. Arbitrary or non-cognitive selection of the CCN is not efficient, at least from the perspective of CCNs coexisting with the primary networks and not interfering with them. These CCNs may be operating on frequencies within the bands which are opened for secondary users.

There are some channel selection algorithms for multiple different radio standards. See for example IEEE 802.22 and 802.16h and proposals for 802.16. However, a selection of an (heterogeneous) inter-network wireless control channel is not well detailed. What is needed in the art is a way for nodes to cognitively select a CCN to join, which means selecting the CCC of a CCN, when there is already a plurality of CCNs to choose from.

### SUMMARY

In a first aspect thereof the exemplary embodiments of this invention provide a method that comprises: receiving by an apparatus a first message indicating at least one of a number of nodes per cognitive radio network participating to a first cognitive control network and amount of traffic per cognitive radio network participating to the first cognitive control network; receiving by the apparatus a second message indicating at least one of a number of nodes per cognitive radio network participating to a second cognitive control network and amount of traffic per cognitive radio network participating to the second cognitive control network; and selecting one of the first cognitive control network and the second cognitive control network based at least partly on at least one of the number of participating nodes and the amount of traffic per similar cognitive radio network for which the apparatus is capable of accessing.

In a second aspect thereof the exemplary embodiments of this invention provide a memory storing a program of computer readable instructions that when executed by a processor result in actions comprising: receiving a first message indicating at least one of a number of nodes per cognitive radio network participating to a first cognitive control network and amount of traffic per cognitive radio network participating to the first cognitive control network; receiving a second message indicating at least one of a number of nodes per cognitive radio network participating to a second cognitive control network and amount of traffic per cognitive radio network participating to the second cognitive control network; and selecting one of the first cognitive control network and the second cognitive control network based at least partly on at least one of the number of participating nodes and the amount of traffic per similar cognitive radio network for which an apparatus hosting the memory is capable of accessing.

In a third aspect thereof the exemplary embodiments of this invention provide an apparatus comprising at least one processor and at least one memory including computer program code. The at least one memory and the computer program code are configured to, with the at least one processor, cause the apparatus to: receive a first message indicating at least one of a number of nodes per cognitive radio network participating to a first cognitive control network and amount of traffic per cognitive radio network participating to the first cognitive control network; receive a second message indicating at least one of a number of nodes per cognitive radio network participating to a second cognitive control network and amount of traffic per cognitive radio network participating to the second cognitive control network; and select one of the first cognitive control network and the second cognitive control network based at least partly on at least one of the number of participating nodes and the amount of traffic per similar cognitive radio network for which the apparatus is capable of accessing.

These and other aspects are detailed below with particularity.

### BRIEF DESCRIPTION OF THE DRAWINGS:

The foregoing and other aspects of these teachings are made more evident in the following Detailed Description, when read in conjunction with the attached Drawing Figures.

FIG. 1 is a schematic diagram of a node with a CCR scanning and discovering two CCNs in its area that are too far to hear one another directly, and represent an environment in which exemplary embodiments of the invention may be practiced.

FIG. 2 is a schematic diagram similar to FIG. 1 but in which the node with a CCR joins both of the CCNs in a time-sharing manner.

FIG. 3 is a table illustrating a list of predefined frequency channels in a predefined order for scanning by a node with a CCR and with fields indicating analysis results after applying a first example of CCN establishment rules according to an exemplary embodiment of the invention.

FIG. 4 is a table similar to FIG. 3 but indicating analysis results after applying a second example of CCN establishment rules according to an exemplary embodiment of the invention.

FIG. 5 is a table similar to FIG. 3 but indicating analysis results after applying a third example of CCN establishment rules according to an exemplary embodiment of the invention.

FIG. 6 is a plan and sectional view of a cognitive control radio embodied as a mobile user equipment UE according to an exemplary embodiment of the invention.

FIG. 7 is a schematic process flow diagram showing operation of a method, and execution of computer executable software stored on a memory, according to an embodiment of the invention.

### DETAILED DESCRIPTION

Embodiments of this invention provide a method, executed from the perspective of the cognitive control radio or its user, and an apparatus which may be the CCR itself or one or more components thereof, and a computer readable program stored on a computer readable memory. The context of this description is that the node is seeking a CCN to join. In an exemplary embodiment the node scans a plurality of predefined frequency channels in a predefined order. As noted in the above background there are certain instances in which CCNs may use a fixed frequency channel for control information such as for example sharing spectrum sensing results. User traffic on any given CRN may be over dynamically changing assemblages of spectrum holes. Since various secondary users may be capable of different and non-overlapping technologies it is anticipated that the CCN will have at least one control channel that is fixed frequency. The node receives a first message indicating a number of radio nodes participating to a first CCN that is of a given radio technology, and a second message indicating a number of radio nodes per radio technology (CRN) participating to a second CCN, and so forth for the pre-existing CCNs. By example and not by way of limitation, IEEE 802.22, IEEE 802.11 and WLAN whitespace are all different CRNs. The node then selects one cognitive control network CCN according to predefined selection rules, and communicates (as in a two way message exchange of data or control signals or some combination of them both) in a CCN. Each CCN has one CCC in an embodiment.

Certain of the examples below arise from the channel scan resulting in the node finding more than one CCN. In an example for this case the selected CCN is on one of the plurality of the predetermined frequency channels from the original scan, which the node selects which one is most suitable based on the selection rules. In one embodiment the rules have the node select the CCN based at least partly on the number of participating radio nodes per cognitive radio network, where the specific CRN is one for which the node has the capability to access and communicate. Specifically, in an embodiment this rule has the node selects the CCN having the largest number of participating radio nodes that use a specific CRN (or at least similar CRNs, such as for example the number of nodes that use time division multiple access TDMA type CRNs for their user data). For the case in which the node scans and finds only one CCN which is suitable, there is only that one CCN to join and so the predetermined selection rules are not relevant since no choice is presented to the node.

Certain other of the examples below arise from the channel scan resulting in the node finding no CCNs at all. In this case the discovering node, having found no existing cognitive control networks, may choose to establish a new CCN using predetermined establishment rules for establishing a new CCN.

The description below assumes that it is the node with the CCR operating the method described, but certain exemplary embodiments of the invention do not need an entire node with CCR to implement the method or execute the computer program; one or more components of the node may perform the relevant steps and functions detailed below. By example, the host device as apparatus might monitor a control channel to receive control messages from multiple other nodes already on an established CCN and count those other nodes in order to apply the selection rules detailed below. Or the apparatus might be a host layer of a mobile handset device which receives the count of other nodes per CRN type from other logical layers of the device. By further example the predefined frequency channels and the predefined order are stored on a local memory of the node, and may first come to be stored there after being downloaded from a database such as by example but not by limitation any of the database populating and accessing techniques noted in the references cited in the above background section. Alternatively the predefined channels and predetermined order may first come to be stored on the node's local memory after the nodes receives them over a cognitive control pilot channel, of which the references cited in the above background section also give non-limiting examples.

The rules for channel selection and network establishment may also be obtained via a database or a cognitive control pilot channel. For example, they may be obtained directly or an algorithm may be obtained from the database or pilot channel and the algorithm gives the actual predefined order and/or predefined frequencies. For example, such an algorithm may stipulate that the predefined frequency channels consist of all channels of the band which are open for secondary use. In another example the algorithm may stipulate that the predefined order is a frequency order (for example, starting from the lowest frequency channel and if that's not suitable then selecting one step higher frequency channel, and so forth). Such a predefined order and/or algorithm may alternatively be specified by a standard of procedures for cognitive networks (or primary networks which stipulate specifics of how secondary users must operate) in which case those algorithms would not normally be dynamically changed by a database or pilot channel. The predetermined frequency channels may be set forth directly in such a communications standard. The predefined order may be a frequency order (ascending or descending) also set forth in such a standard.

Note that in the context of secondary users, it is important to recognize that searching for a pre-existing CCN or for temporarily unused ‘holes’ in a bandwidth are power intensive operations from the perspective of a mobile apparatus such as would typically embody a node or CCR, and so having a list of frequency channels and a specific order for scanning them aids in assuring efficient use of the node's limited power supply for at least discovering existing CCNs around it. Having a set of channel selection rules for the case where a node's scan reveals multiple CCNs in its area is a power-efficient way to assure that discovering nodes join the most appropriate control network given the environment the node finds itself in, without having to analyze that environment such as by cyclostationary feature detection and other analytic techniques. For this reason the specific sequence of the actions to complete successful CCN channel selection is defined for both access point AP and non-AP type of devices. (Note that whether a particular device is AP or non-AP is often independent of the device hardware itself and reflects the functions of the device in the CCN).

The node with CCR can detect the CCN frequency by scanning through a series of predefined frequency channels in a predefined order. By example and not by way of limitation the predefined order may be to scan the lowest frequency channel in the band, or highest frequency, and progressively move to the next frequency channel if a CCN is not found or if for some other reason another CCN must be found (the earlier-found CCN is too weak to communicate with for example).

The CCC may be a logical channel or a physical channel which is used to send control messages within a CCN. The node with CCR trying to discover a physical CCC would scan the networks using the predefined frequencies, then the node associates to the CCN.

For the case in which there are two CCNs joined by some relay or joining node, the discovering node can discover that merged CCN via the CCC of the merged CCN. If the discovering node finds information of a CCN which it would like to join, it can associate to that CCN and access the CCC from there. In this case the node may stay associated to the network it first joined and stay on that network's CCC, such as for example if it is exchanging user traffic over a CRN with one or more other nodes which are also on that CCN. Or the discovering node/CCR may disassociate from that network. The channel selection rules are relevant for selecting one of the CCCs, for the case where the CCR finds a plurality of CCNs. The channel establishment rules are relevant for choosing a (new) CCC, for the case where the CCR finds no CCN during its scan of channels.

The below example embodiments of the invention assume that heterogeneous user networks in the area that are connected (or that may be connected/merged by the discovering node with CCR, as will be detailed) in a manner that enables coexistence communication between them, such as for example spectrum negotiations between secondary users, communication opportunity detection for user data communication (for example, discovery of existing networks, and peer discovery for ad hoc communication), and sharing of spectrum sensing results and sensing responsibilities between connected networks and nodes on the connected networks.

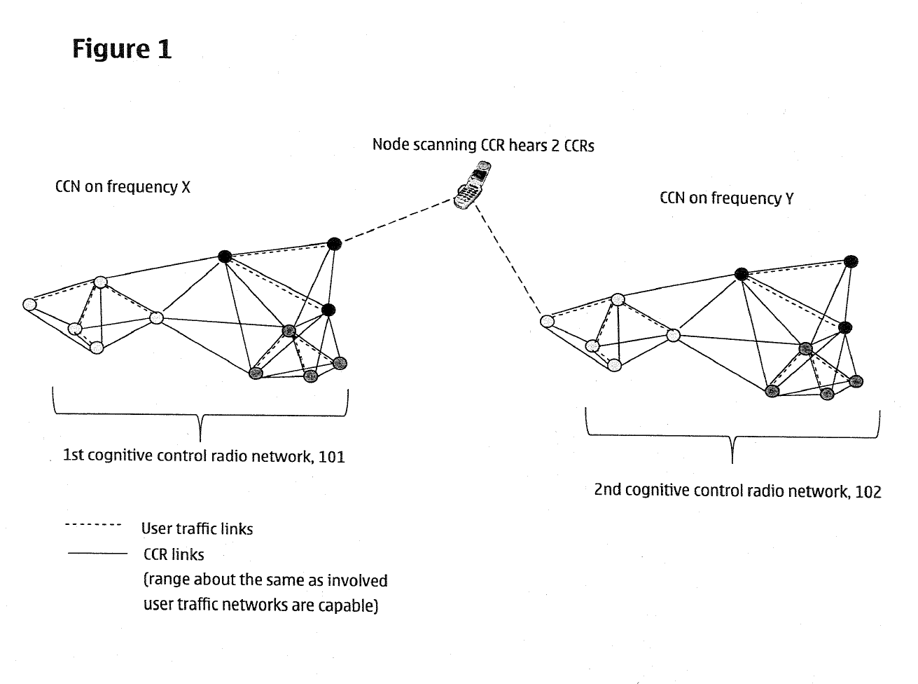

The discovering node with CCR searching for a CCN may discover multiple CCNs. Examples of why this might happen include that the density of other nodes already in one CCN may be low, and some of the nodes have not heard each other and so two CCNs have been established. The discovering node may be in a position that it hears both CCNs. This situation is shown at FIG. 1. There is a first CCN 101 whose CCC is on frequency channel X and a second CCN 102 whose CCC is on frequency channel Y. The discovering node 10 scans in the predetermined order through its list of frequency channels which include X and Y, and finds those two CCNs 101, 102. Then using its channel selection rules it determines which of the CCNs it wishes to join.

In an exemplary embodiment, the channel selection rules which the discovering node 10 uses to select which is the most suitable CCN qualify the CCNs/CCCs in the following order. First, the CCN is selected that is on the frequency channel which seems free from primary users (e.g. wireless microphones). If there is only one such CCN, then that is the one that the discovering node 10 uses for its cognitive radio control information communications. If there are more than one CCN using such primary-free frequency channels, then in an embodiment the next channel selection rule directs that the discovering node selects the CCN which has the highest number of devices/users using a similar cognitive radio network which is compatible with the discovering node's capabilities. Per similar CRN is in an embodiment those cognitive radio networks which use a similar multiplexing technology for their user traffic (for example, all nodes/networks that use TDMA for exchanging user data).

By example, at FIG. 1 the discovering node 10 discovers two CCNs each having nodes with different types of traffic networks. The node 10 then evaluates whether the discovered CCNs contain nodes which use the same or similar type of traffic network as the discovering node 10. For example, if the discovering node 10 is only IEEE 802.22 capable and an existing CCN had one 802.11 CRN with 4 devices and one 802.22 CRN with 3 devices, the discovering node would count only 3 nodes on the CRN according to this exemplary rule. In one embodiment, this could also be based on the amount of networks. E.g. in CCN there would be 3 802.22 networks and 1 802.11 network.

Alternatively, or in addition, another channel selection rule directs that the discovering node selects the first CCN if it has the highest amount of traffic per same/similar cognitive radio network as the discovering node. In this embodiment there may be fewer nodes but higher traffic volume per same/similar CRN as compared to volume per CRN that are participating to a second CCN (which may have a higher number of nodes), and this embodiment would have the node select the first CCN since it has the higher traffic amount.

In another embodiment assume as in FIG. 1 that the discovering node 10 discovers from its scan two or more CCNs of the same type (for example, 802.11-type CCN or 802.22-type CCN), and the discovering node is compatible with that type. The discovering node 10 may choose to merge those same-type networks, even if there are different numbers of participating users and the selection rules have the node selecting only one of those same-type CCNs. By example, the discovering node 10 can merge those CCNs by informing all the other nodes in those CCNs that there are multiple CCNs in the area, and in an embodiment specifically sending those other nodes an indication of a merging/joining channel where all nodes should join. In an example embodiment the merging channel is selected according to the CCN establishment rules which are detailed further below.

This merging operation is seen to be quite useful for the case shown in FIG. 1 in which the two networks 101, 102 are not sufficiently close to hear one another or are on different frequencies and thus cannot hear one another and the position of the discovering node 10 is such that this node 10 can bridge the two separate networks. That same node 10 can also bridge two CCNs that have nodes of different types, for example if the first network 101 has nodes operating under IEEE 802.22 and 802.11 with channel X as the CCC and the second network 102 also has nodes operating under IEEE 802.22 and 802.11 but uses channel Y as the CCC. This assumes of course that the node 10 is capable of communicating over both types of CCNs. Regardless of whether there are similar or disparate network types, such a merge is highly useful if the two CCNs 101, 102 which were once far apart have grown to the point where they overlap. The node 10 may decide that merging is not efficient if the distances between the networks are such that sharing CCN information, such as for example sensing information for finding spectrum holes or spectrum negotiation information, among the different nodes of those different cognitive networks would not be sufficiently beneficial.

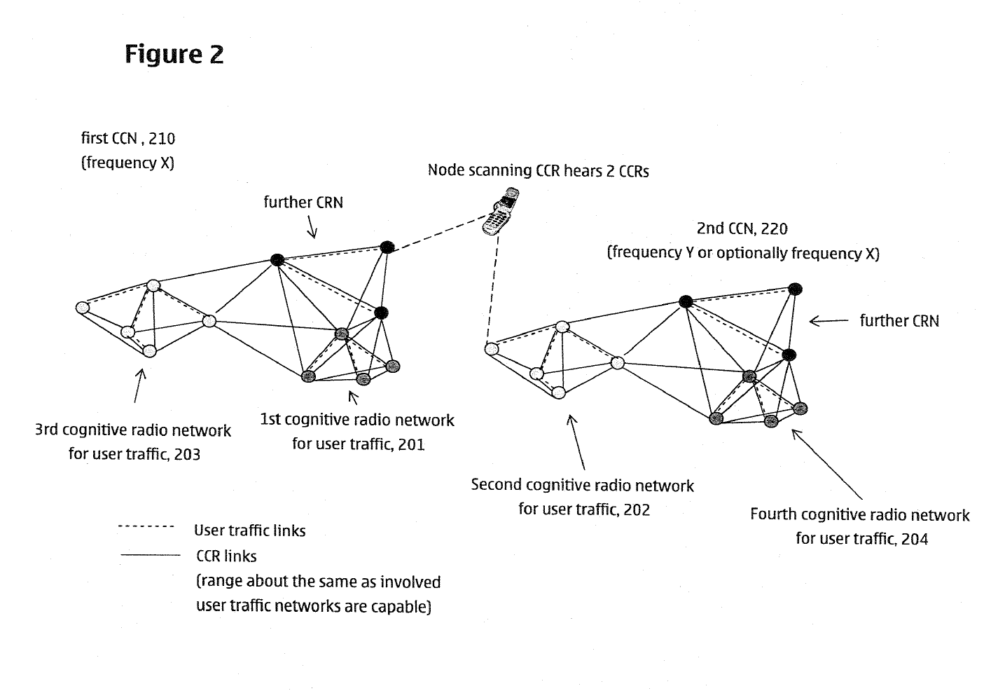

Now assume as in FIG. 2 that the discovering node 10 discovers from its scan two (or more) CCNs each having nodes in different CRNs, and that the node 10 chooses not to merge them. In this example nodes in the first CRN 201 send user traffic according to IEEE 802.11 rules and nodes in the third CRN 203 send user traffic according to some new cognitive technology not yet developed but which has similar access aspects as the first CRN 201 There is a further CRN with also a similar access technology, and so those three CRNs each share a CCC (channel X in FIG. 2) for communicating control data over their common first CCN 210. Similarly, nodes in the second CRN 202 send user traffic according to IEEE 802.22 rules and nodes in the fourth CRN 204 send user traffic according to some new CRN technology not yet developed but which has similar access aspects as the second CRN 202. There is also a further CRN with also a similar access technology, and so those three CRNs each share a CCC (channel Y in FIG. 2) for communicating control data over their common second CCN 220. Note that both CCNs 210, 220 may also use the same frequency, such as for example when they are too far apart to ‘hear’ one another.

While the above example has each CCN with only similar type CRNs within that CCN, this is not a necessary limit to which CRNs may use a common CCN. There are benefits if nodes having similar CRN capability are in the same CCN, but that is not a restriction. In addition, it is beneficial if CCR is only one technology and there would be only one CCN in an area; then all CRNs in that area could agree about the spectrum usage. On the other hand, if the CCN grows large (not only local), then also the amount of signaling in the CCN increases, and all the information is not relevant for all the nodes/networks.

The discovering node 10 can use the channel selection rules as above to select which one of the CCNs 210, 220 to join, and it may also use the channel selection rules to also join to a different type CCN. That is, the node 10 may apply the rules on a type-network basis, joining the one network type which has the greater number of nodes participating to its CCN, and associate itself simultaneously to the other type CCN(s), for example by time-sharing its own radio resources to access the different CCNs in a time division duplex manner. Due to the different CRN access techniques, it may not be appropriate for the discovering node 10 to merge the first CCN 210 with the second CCN 210.

Once the discovering node 10 performs its scan of the predetermined frequency channels in the predetermined order, it may for some reason decide to form a new CCN. Such a reason may be for example that the node 10 found no CCNs from its scan and so no single channel is selected based on the number of participating nodes per CRN. It may be that in fact there are no other nodes in the area that are using whitespaces for secondary communications, or it may be that there are nodes but none of them have established a CCN and are only capable of performing CCN discovery but are not discoverable themselves (and can therefore associate to a new CCN established by another node even though they cannot establish a CCN themselves). Or for example the discovering node 10 may have found one or more CCNs but none of them are qualified according to the rules as a ‘find’. This may be the case if for example the rules stipulate a minimal signal strength and all of the CCNs which the node 10 heard are below the signal strength (or other) threshold, of if the node 10 is using the rules to search for a particular type of CCN and none of the CCNs in the area are of that type.

For the case in which the scan by the discovering node 10 of the predefined frequency channels yields no suitable CCC, the channel selection rules may then inform the node 10 how to choose one of the predetermined frequency channels for establishing a new CCN. This set of the rules are termed herein as CCN establishment rules. The node 10 uses them to choose a CCN and establishes a new CCN using one of the original predetermined frequency channels. This enables other discovering nodes to easily find the newly established CCN.

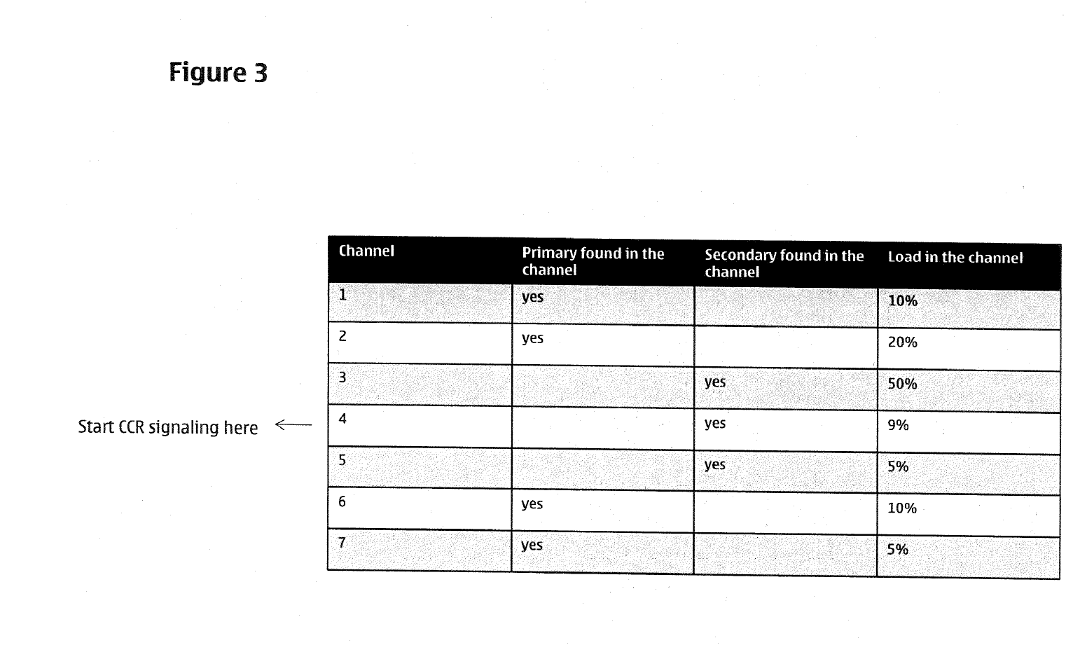

In an example embodiment, the CCN establishment rules for choosing the most suitable frequency for establishing a CCN is that the channel is chosen which is the first frequency channel of the predetermined order which is free of primary users and whose load is below a predefined threshold level. An example of this is shown at FIG. 3, which illustrates a stored list of frequency channels numbered 1 through 7. Assume the predefined threshold level is 10% loading. The node 10 scans the channels in that order, with results shown in the other columns of the FIG. 3 table. Channels 1 and 2 do not qualify under this example establishment rule because primary users are found there. No primary users are found on channel 3, but the channel loading is 50% which exceeds the 10% threshold and so channel 3 is not chosen. No primary users are found on channel 4 also, and since the channel loading of 9% is less than the 10% threshold assumed above the node 10 chooses channel 4 to establish a new CCN. At this point the node 10 can disregard the remaining channels 5 through 7 since it has found the first suitable channel under the highest priority establishment rule. Alternatively the node 10 scans all 7 channels in the list and posts results as shown, then chooses the first one (channel 4) that is suitable under the establishment rules. In the case of FIG. 3 the node 10 sets up a CCN using channel 4.

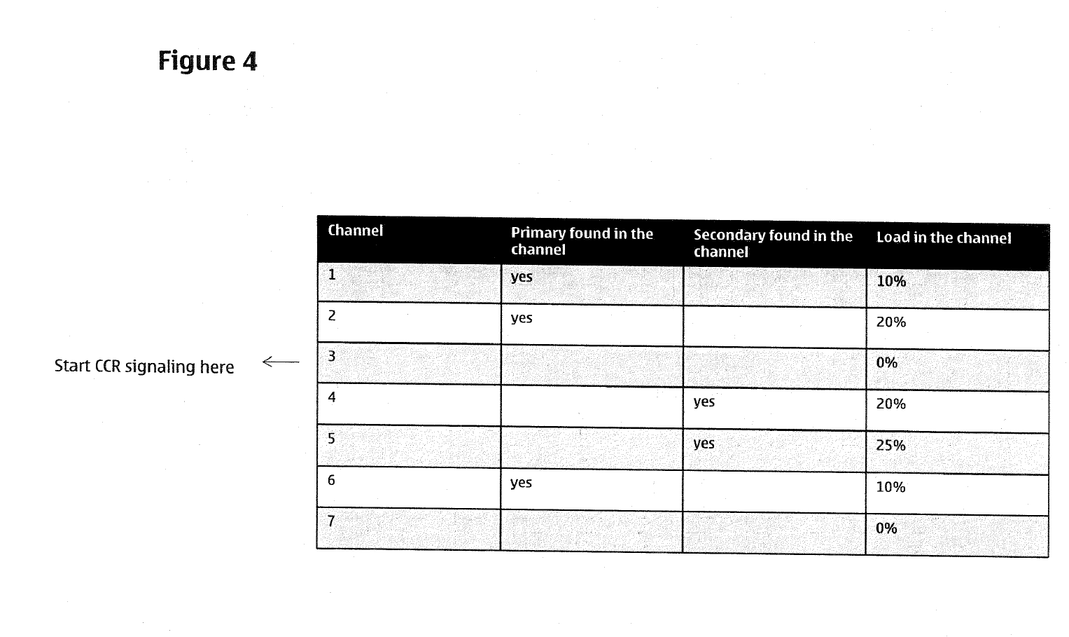

In another example embodiment, the CCN establishment rules for choosing the most suitable frequency for establishing a CCN is that the channel is chosen which is the first frequency channel of the predetermined order which is free of primary users. This is shown at FIG. 4 which is similar to FIG. 3 but with different scan results. Channels 1 and 2 have a primary user and so are not suitable. Channel 3 has no primary user and so is chosen as the suitable channel since it is the first in the predetermined order 1 through 7 to meet the establishment rules. Channels 4, 5 and 7 also have no primary user but are not the first channel in the predefined order to satisfy the establishment rules. Channel 6 has a primary user. In the case of FIG. 4 the node 10 sets up a CCN using channel 3.

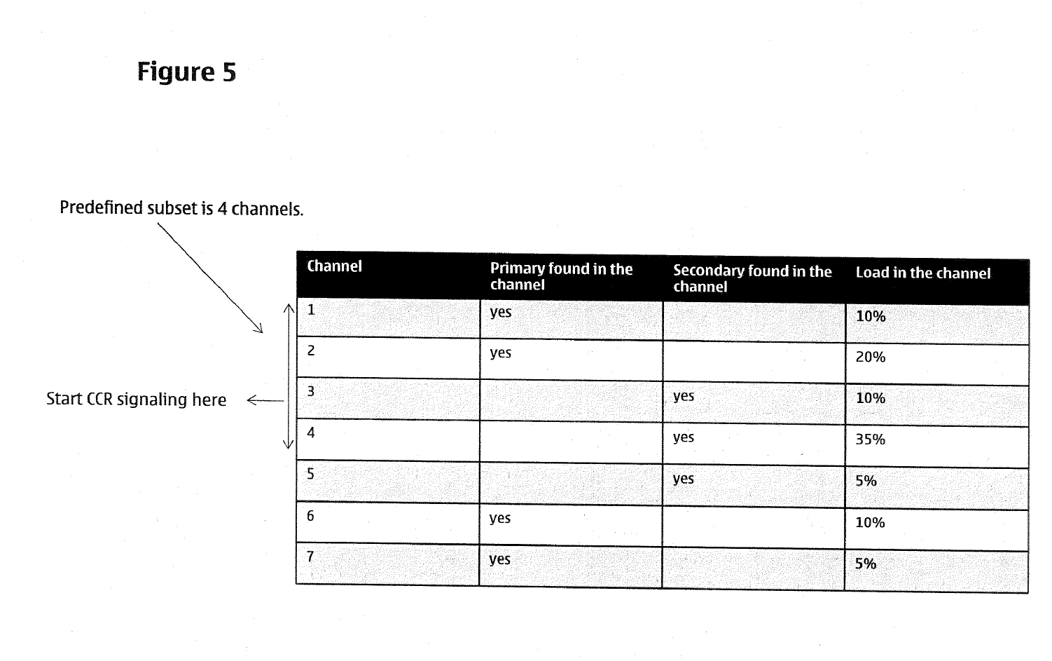

In another example embodiment, the CCN establishment rules for choosing the most suitable frequency for establishing a CCN is that the channel is chosen which is the lowest loaded frequency channel of a subset of the predetermined order which is free of primary users. This third example is shown at FIG. 5, also similar to FIG. 3 but with different scan results. In this example the subset is channels 1 through 4. Channels 1 and 2 have a primary user. Channels 3 and 4 have respective loading of 10% and 35%. Since the establishment rule in this case is lowest loading of the subset which is free of primary users, channel 3 is chosen by this establishment rule and the node 10 establishes a new CCN using channel 3 of FIG. 5.

Other channel selection establishment rules may be included alongside those detailed above for FIG. 5, such as for the case in which there are no channels in the first subset that are free of primary users, then choosing the lowest loaded channel in a second subset (mutually exclusive of the first subset) of the listing that is free of primary users. This may be repeated for other subsets until all channels in the list are covered.

Tables similar to those at FIGS. 3-5 can be applied for the channel selection rules detailed above, in which case the secondary user column can be used to indicate presence or not of an existing CCN which is relevant to the channel selection rules for existing CCNs.

Certain nodes may not be capable of forming a CCN even though they are capable of joining an existing one. There may also be circumstances in which a particular node 10 is capable of forming a CCN but chooses not to do so (for example, low battery level). In this case the node can use the embodiment noted above in which the channel selection rules are network-type specific and select the suitable type CCN which has the greatest number of nodes participating. For example, the channel selection rules can select the most suitable CCN by choosing a CCN which indicates presence of suitable type (such as 802.11 or 802.22 or WLAN whitespace for example) of traffic network. By example this indication can be automatic as in a beacon or can be in response to query from the discovering node 10. The selection rules may also stipulate that the discovering node 10 check the quality of the traffic network link to verify the selection or to re-consider it.

The ‘suitable type’ CCN is one for which the node is capable of accessing and using as a control channel for co-existence communications between multiple different networks, ‘suitable’ meaning it satisfies the predetermined selection criteria. In one example a suitable CCN is one that is free of primary users, and which has the greatest number of nodes belonging to similar traffic networks (for example, each of those nodes using TDMA for its user traffic).

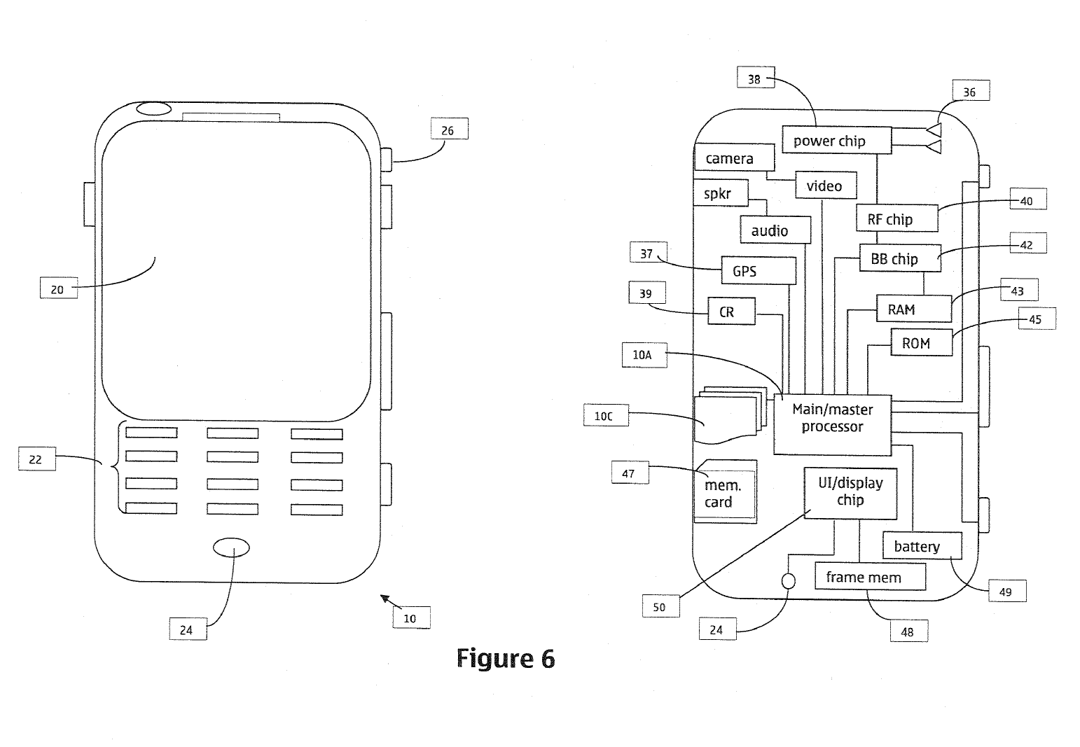

FIG. 6 illustrates detail of an exemplary node 10 embodied as a mobile station MS or user equipment UE in both plan view (left) and sectional view (right), and the invention may be embodied in one or some combination of those more function-specific components. At FIG. 6 the node 10 has a graphical display interface 20 and a user interface 22 illustrated as a keypad but understood as also encompassing touch-screen technology at the graphical display interface 20 and voice-recognition technology received at the microphone 24. A power actuator 26 controls the device being turned on and off by the user.

Within the sectional view of FIG. 6 are seen multiple transmit/receive antennas 36 that are typically used for cellular communication. The antennas 36 may be multi-band for use with other radios in the UE. The power chip 38 controls power amplification on the channels being transmitted and/or across the antennas that transmit simultaneously. The power chip 38 outputs the amplified received signal to the radio-frequency (RF) chip 40 which demodulates and downconverts the signal for baseband processing. The baseband (BB) chip 42 detects the signal which is then converted to a bit-stream and finally decoded. Similar processing occurs in reverse for signals generated in the apparatus 10 and transmitted from it.

The graphical display interface 20 is refreshed from a frame memory 48 as controlled by a user interface chip 50 which may process signals to and from the display interface 20 and/or additionally process user inputs from the keypad 22 and elsewhere.

Certain embodiments of the node 10 also include one or more secondary radios such as a cognitive radio 39 and a global positioning receiver 37, either or both of which may incorporate an antenna on-chip or be coupled to an off-chip antenna. In another embodiment the cellular radio(s) embodied at FIG. 6 as the combined BB chip/RF chip/power chip are used for communications over the cognitive network(s) as well as hierarchical cellular networks. Throughout the apparatus are various memories such as random access memory RAM 43, read only memory ROM 45, and in some embodiments removable memory such as the illustrated memory card 47 on which the various computer executable software programs 10C are stored. All of these components within the node 10 are normally powered by a portable power supply such as a galvanic battery 49.

The aforesaid processors 38, 40, 42, 44, 46, 50, if embodied as separate entities in a node 10, may operate in a slave relationship to the main processor 10A, which may then be in a master relationship to them. Embodiments of this invention may be disposed across one or various chips and memories as shown or disposed within a different processor that combines some of the functions described above for FIG. 6. Any or all of these various processors of FIG. 6 access one or more of the various memories, which may be on-chip with the processor or separate therefrom.

Note that the various chips (e.g., 38, 40, 42, etc.) that were described above may be combined into a fewer number than described and, in a most compact case, may all be embodied physically within a single chip.

At least one of the computer readable software programs 10C is assumed to include program instructions that, when executed by the associated DP, enable the device to operate in accordance with the exemplary embodiments of this invention as detailed above. That is, the exemplary embodiments of this invention may be implemented at least in part by computer software executable by the DP 10A of the node 10, or by hardware, or by a combination of software and hardware (and firmware).

In general, the various embodiments of the node 10 can include, but are not limited to, cellular telephones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

The computer readable memories shown variously at FIG. 6 may be of any type suitable to the local technical environment and may be implemented using any suitable data storage technology, such as semiconductor based memory devices, flash memory, magnetic memory devices and systems, optical memory devices and systems, fixed memory and removable memory. The various processors/chips may be of any type suitable to the local technical environment, and may include one or more of general purpose computers, special purpose computers, microprocessors, digital signal processors (DSPs) and processors based on a multicore processor architecture, as non-limiting examples.

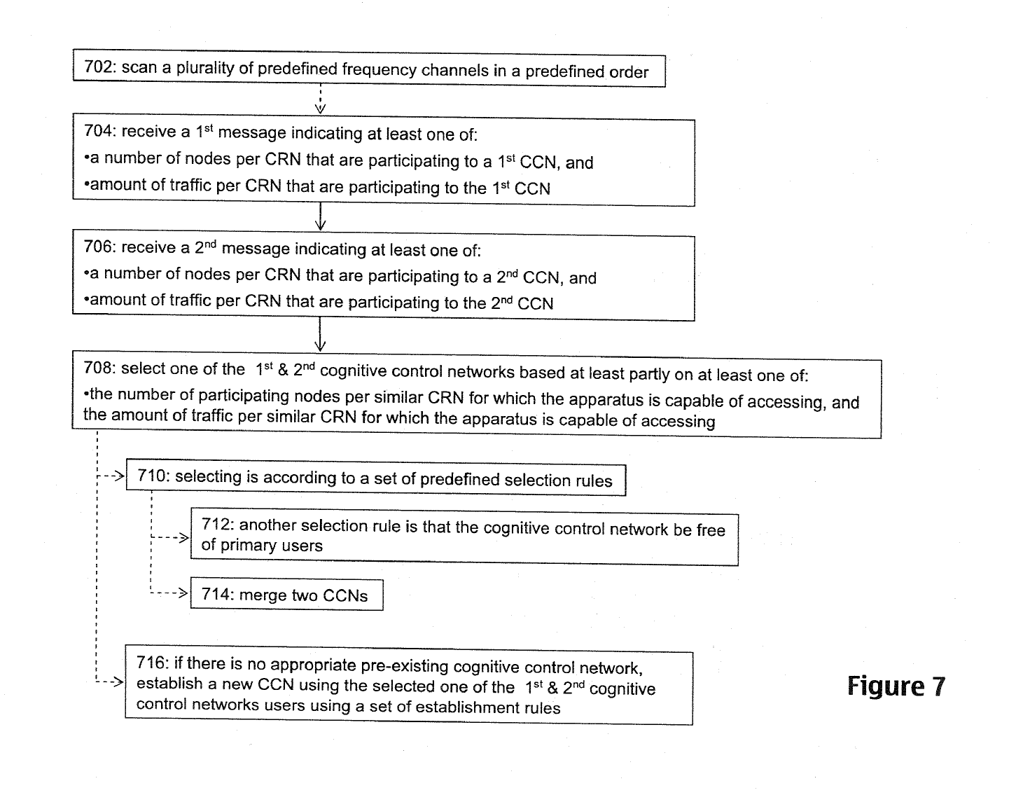

FIG. 7 is a logic flow diagram that illustrates the operation of a method, and a result of execution of computer program instructions, in accordance with the exemplary embodiments of this invention. Also FIG. 7 describes functionality of an apparatus such as the node with cognitive control radio according to an embodiment these teachings. In accordance with these exemplary embodiments at preliminary block 702 the apparatus scans a plurality of predefined frequency channels in a predefined order. At block 704 the apparatus receives a first message indicating at least one of a number of nodes per CRN that are participating to a first CCN and amount of traffic per CRN that are participating to the first CCN. The number of nodes or amount of traffic may be per similar CRN such as TDMA technology, or the number of nodes or amount of traffic may be per same CRN. At block 706 the apparatus receives a second message indicating at least one of a number of nodes per CRN that are participating to a second CCN and amount of traffic per CRN that are participating to the second CCN. At block 708 the apparatus then selects one of the first CCN and the second CCN, based at least partly on at least one of the number of participating nodes per CRN or the amount of traffic per CRN for which the apparatus is capable of accessing (which as above may be all technologies that the apparatus is technologically capable of accessing or it may be further limited by subscriber roaming agreements which control access by the apparatus).

The predefined frequency channels and the predefined order may be stored on a local memory of a node with cognitive control radio. An example of the predefined order for block 702 is a frequency order (ascending or descending). Other portions of FIG. 7 give various exemplary embodiments that are detailed with further particularity above.

At block 710 there is a set of predefined selection rules by which the apparatus makes the selection at block 708, and by example at block 712 another one of those predefined selection rules is to select the first or second CCN which appears to be free of primary users. This rule at block 712 can be executed prior to the block 708 rule or after. For example, all channels that are free of primary users are then evaluated for which one has the highest number of participating nodes in a CRN for which the apparatus is capable of accessing.

Another example of the predefined selection rules of block 710 is: if more than one cognitive control network is found by the scanning, select the cognitive control network based on type of cognitive control network; and for the case in which there is more than one cognitive control network of a given type, select the cognitive control network of the given type based on cognitive control channel quality.

At block 714, the apparatus merges at least two cognitive control networks, such as by informing cognitive control radios of a merging/joining channel that is selected according to predetermined establishment rules for establishing a new cognitive control network. At block 716, for the case that scanning the predefined frequency channels at block 702 yields no suitable cognitive control network, then the selecting at block 708 means choosing one of the predetermined frequency channels according to predetermined establishment rules for new cognitive control networks and establishing a new cognitive control network using the chosen predetermined frequency channel.

One example of such predefined establishment rules for block 716 is: choose the frequency channel which is free of primary users and which is loaded below a predefined threshold; and for the case where all of the primary-free frequency channels are loaded above the predefined threshold, choose the frequency channel that is first in a predefined order.

Another example of such predefined establishment rules for block 716 is: choose the frequency channel which appears to be free of primary users; and for the case where none of the frequency channels appears to be free of primary users, either choose the frequency channel of a specific type of cognitive control network that is first in a predefined order; or choose the frequency channel which is loaded below a predefined threshold.

Another example of such predefined establishment rules for block 716 is: choose the frequency channel within a first predefined subset of the plurality of predefined frequency channels which has a lowest loading and is free of primary users; and for the case where none of the frequency channels is free of primary users, choose the frequency channel within a second predefined subset of the plurality of predefined frequency channels which has a lowest loading. In these examples each CCN corresponds to only one frequency channel.

The various blocks shown in FIG. 7 may be viewed as method steps, and/or as operations that result from operation of computer program code, and/or as a plurality of coupled logic circuit elements constructed to carry out the associated function(s).

In general, the various embodiments may be implemented in hardware or special purpose circuits, software (computer readable instructions embodied on a computer readable medium), logic or any combination thereof. For example, some aspects such as the sequence generator may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation such as FIGS. 6 and 7, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

Embodiments of the inventions may be practiced in various components such as integrated circuit modules. The design of integrated circuits ICs is by and large a highly automated process. Complex and powerful software tools are available for converting a logic level design into a semiconductor circuit design ready to be etched and formed on a semiconductor substrate. FIG. 7 may also represent specific circuit functions of an integrated circuit or chip.

Various modifications and adaptations may become apparent to those skilled in the relevant arts in view of the foregoing description, when read in conjunction with the accompanying drawings. However, any and all modifications of the teachings of this invention will still fall within the scope of the non-limiting embodiments of this invention.

Although described in the context of particular embodiments, it will be apparent to those skilled in the art that a number of modifications and various changes to these teachings may occur. Thus, while the invention has been particularly shown and described with respect to one or more embodiments thereof, it will be understood by those skilled in the art that certain modifications or changes may be made therein without departing from the scope and spirit of the invention as set forth above, or from the scope of the ensuing claims.

1. A method comprising:
receiving, by an apparatus, a first message indicating at least one of a number of nodes per cognitive radio network participating to a first cognitive control network and amount of traffic per cognitive radio network participating to the first cognitive control network;
receiving, by the apparatus, a second message indicating at least one of a number of nodes per cognitive radio network participating to a second cognitive control network and amount of traffic per cognitive radio network participating to the second cognitive control network; and
selecting one of the first cognitive control network and the second cognitive control network based at least partly on at least one of the number of participating nodes and the amount of traffic per similar cognitive radio network for which the apparatus is capable of accessing.

2. The method according to claim 1, further comprising scanning a plurality of predefined frequency channels in a predefined order;
in which the predefined frequency channels and the predefined order are stored in a local memory of the apparatus;
and in which receiving the first message and the second message result from the scanning.

3. The method according to claim 2, in which at least one of the first and second cognitive control network uses a logical channel as a cognitive control channel.

4. The method according to claim 2, in which selecting one of the first and second cognitive control networks is according to a selection rule that is part of a predefined set of selection rules stored in a local memory of the apparatus.

5. The method according to claim 4, in which the set of predefined selection rules further comprise selecting one of the predefined frequency channels which appears to be free of primary users.

6. The method according to claim 4, in which selecting the one of the first and second cognitive control channels comprises:
merging at least two cognitive control networks by informing cognitive control radios of a joining channel, in which the joining channel is selected according to predetermined establishment rules for establishing a new cognitive control network.

7. The method according to claim 2, in which at least one of the plurality of predefined frequency channels and the predefined order is obtained by the apparatus wirelessly from a database.

8. The method according to claim 1, wherein the first and second cognitive control networks use control channels for co-existence communications between different cognitive radio networks for operating on at least a partially overlapping frequency spectrum.

9. The method according to claim 1, wherein the different cognitive radio networks comprise networks for operating on different radio technologies.

10. A memory storing a program of computer readable instructions that when executed by a processor cause an apparatus to:
receive a first message indicating at least one of a number of nodes per cognitive radio network participating to a first cognitive control network and amount of traffic per cognitive radio network participating to the first cognitive control network;
receive a second message indicating at least one of a number of nodes per cognitive radio network participating to a second cognitive control network and amount of traffic per cognitive radio network participating to the second cognitive network; and
select one of the first cognitive control network and the second cognitive control network based at least partly on at least one of the number of participating nodes and the amount of traffic per similar cognitive radio network for which an apparatus hosting the memory is capable of accessing.

11. The memory according to claim 10, the wherein the instructions when executed further cause the apparatus to scan a plurality of predefined frequency channels in a predefined order;
in which the predefined frequency channels and the predefined order are stored in the memory;
and in which receiving the first message and the second message result from the scanning.

12. The method according to claim 10, in which selecting one of the first and second cognitive control networks comprises:
merging at least two cognitive control networks by informing cognitive control radios of a joining channel, in which the joining channel is selected according to predetermined establishment rules for establishing a new cognitive control network.

13. (canceled)

14. An apparatus comprising:
at least one processor;
at least one memory including computer program code;
the at least one memory and the computer program code configured to, with the at least one processor, cause the apparatus to:
receive a first message indicating at least one of a number of nodes per cognitive radio network participating to a first cognitive control network and amount of traffic per cognitive radio network participating to the first cognitive control network;
receive a second message indicating at least one of a number of nodes per cognitive radio network participating to a second cognitive control network and amount of traffic per cognitive radio network participating to the second cognitive control network; and
select one of the first cognitive control network and the second cognitive control network based at least partly on at least one of the number of participating nodes and the amount of traffic per similar cognitive radio network for which the apparatus is capable of accessing.

15. The apparatus according to claim 14, in which the memory and the computer program code are configured with the at least one processor to further cause the apparatus to:
scan a plurality of predefined frequency channels in a predefined order;
in which the predefined frequency channels and the predefined order are stored in the memory;
and in which the first message and the second message are received as a result of the scan.

16. The apparatus according to claim 15, in which at least one of the first and second cognitive control networks uses a logical channel as a cognitive control channel.

17. The apparatus according to claim 15, in which the first or second cognitive control network is selected according to a selection rule that is part of a predefined set of selection rules stored in the memory.

18. The apparatus according to claim 17, in which the set of predefined selection rules further comprise: select one of the predefined frequency channels which appears to be free of primary users.

19. The apparatus according to claim 17, in which the memory and the computer program code are configured with the at least one processor to further cause the apparatus to select the first or second cognitive control network by merging at least two cognitive control networks by informing cognitive control radios of a joining channel, in which the joining channel is selected by the apparatus according to predetermined establishment rules for establishing a new cognitive control network.

20. The apparatus according to claim 15, in which at least one of the plurality of predefined frequency channels and the predefined order is obtained by the apparatus wirelessly from a database.

21. The apparatus according to claim 14, wherein the first and second cognitive control networks use control channels for co-existence communications between different cognitive radio networks for operating on at least a partially overlapping frequency spectrum.

22. The apparatus according to claim 14, wherein the different cognitive radio networks comprise networks for operating on different radio technologies.
